(19) United States
(12) Patent Application Publication
(10) Pub. No.: US 2012/0290279 A1
(43) Pub. Date: Nov. 15, 2012

(54) SYSTEM AND METHOD FOR PROVIDING ASSESSMENT OF RISK OF ENCOUNTER WITH TICKS

(75) Inventors: Thomas Mather, Wakefield, RI (US); Jean-Yves Hervé, Narraganset, RI (US); Brian Mullen, Greenville, RI (US)

(73) Assignee: Board of Governors for Higher Education, State of Rhode Island and Providence Plantations, Providence, RI (US)

(21) Appl. No.: 13/525,794

(22) Filed: Jun. 18, 2012

Related U.S. Application Data
(63) Continuation of application No. PCT/US10/62345, filed on Dec. 29, 2010.
(60) Provisional application No. 61/290,600, filed on Dec. 29, 2009.

(51) Int. Cl. G06G 7/48

(52) U.S. Cl. 703/11

(57) ABSTRACT

A tick encounter and tick-borne disease prevention decision support system is disclosed for permitting a user to obtain a risk calculation of encountering disease-causing ticks. The tick encounter and tick-borne disease prevention decision support system includes several components. A location component is for receiving data from a user regarding a user's geographic location. A landscape component is for receiving data from the user regarding a type of landscape that exists where the user lives. An animals component is for receiving data from the user regarding any of wildlife or pets that exist where the user lives. A human activity component is for receiving data from the user regarding the user's activities in their yard. The score computation module is for generating a tick risk calculation number based on output data from each of the components.

### PRIORITY

The present application claims priority to U.S. Provisional Patent Application Ser. No. 61/290,600 filed Dec. 29, 2009, the disclosure of which is hereby incorporated by reference in its entirety.

### BACKGROUND

Diseases relating to infectious bites from ticks (Ixodes scapularus) have long been a problem for persons in many parts of the United States. As animals that carry the disease migrate due to changes in human populations and long term weather changes, the population of persons at risk of encountering ticks and contracting such diseases appears to be increasing. Tick repellent systems, tick removal devices, and tick borne disease diagnostic systems are well known.

Tick repellent systems generally include chemical repellents and specially designed clothing. U.S. Pat. Nos. 6,906,108; 6,300,324, 6,103,758 and 4,612,327 for example, generally disclose tick repellent chemicals, and U.S. Pat. Nos. 6,353,939; 6,141,802 generally disclose specially designed tick repellent clothing.

A wide variety of tick removal devices and methods have been developed, including for example, those disclosed in U.S. Pat. Nos. 7,699,869; 7,604,814; 6,808,717; 6,413,266; 6,179,847; 6,106,041; 6,100,501; 5,998,762; 5,914,062; 5,876,409; 5,843,094; 5,792,148; 5,607,434; 5,595,569; 5,556,563; 5,554,161; 5,447,511; 5,407,243; 5,116,347; 5,078,729; 5,002,323; 4,938,764; 4,834,967; 4,748,767; 4,303,268; and 4,213,460 disclose a variety of tick removal devices and methods.

Systems and methods have also been developed for diagnosing tick borne illnesses as disclosed, for example, in U.S. Pat. No. 7,390,626.

While diseases relating to infectious bites from ticks have long been a problem for persons in many parts of the United States, there remains a need for a risk assessment and prevention program that effectively addresses and thereby reduces the problem and threat of infectious bites from ticks. A system is needed, therefore, for tick bite risk assessment and decision support to effect appropriate behavioral change that results in reduced risk of encounters with, and infections from ticks.

### SUMMARY

In accordance with an embodiment, the invention provides a tick bite prevention and decision support system for permitting a user to calculate the risk of encountering a tick in a peridomestic setting. The tick bite prevention and decision support system includes a location component, a landscape component, an animals component, a human activity component, a database, and a score component. The location component is for receiving data from a user regarding a user's geographic location. The landscape component is for receiving data from the user regarding the type of landscape that exists where the user lives. The animals component is for receiving data from the user regarding any of wildlife or pets that exist where the user lives. The human activity component is for receiving data from the user regarding the user's activities in their yard. Statistical inference data is stored on the database, and the database is coupled to each of the location component, landscape component, animals component and the human activity component. The score computation module is for generating a tick encounter risk calculation number based on the output data from each of the location component, the landscape component, the animals component and the human activity component.

In accordance with another embodiment, the invention provides a method of providing a risk calculation that a user will contact a tick. The method includes the steps of: receiving data from a user regarding a user's location, receiving data from the user regarding a type of landscape that exists where the user lives, receiving data from the user regarding any of wildlife or pets that exist where the user lives, receiving data from the user regarding the user's activities in their yard, storing statistical inference data on a database, said database being coupled to each of the location component, landscape component, animals component and the human activity component; and generating a tick encounter risk calculation number. The tick encounter risk calculation number is responsive to the data from a user regarding a user's location, the data from the user regarding a type of landscape that exists where the user lives, the data from the user regarding any of wildlife or pets that exist where the user lives, and the data from the user regarding the user's activities in their yard.

### BRIEF DESCRIPTION OF THE DRAWINGS

The following description may be further understood with reference to the accompanying drawings in which:

FIG. 1 shows an illustrative diagrammatic view of a tick encounter prevention system in accordance with an embodiment of the invention;

FIG. 2 shows an illustrative initial screen view of an interface application of the tick prevention system of FIG. 1;

FIG. 3 shows an illustrative screen view of a town selection interface of the tick prevention system of FIG. 1;

FIG. 4 shows an illustrative screen view of a yard type selection interface of the tick prevention system of FIG. 1;

FIG. 5 shows an illustrative screen view of the yard type selection interface of the tick prevention system of FIG. 1 following selection of a yard type;

FIG. 6 shows an illustrative screen view of a yard details selection interface of the tick prevention system of FIG. 1;

FIG. 7 shows an illustrative screen view of a wildlife selection interface of the tick prevention system of FIG. 1;

FIG. 8 shows an illustrative screen view of a pets/dogs selection interface of the tick prevention system of FIG. 1;

FIG. 9 shows an illustrative screen view of a pets/cats selection interface of the tick prevention system of FIG. 1;

FIG. 10 shows an illustrative screen view of an outdoor activities selection interface of the tick prevention system of FIG. 1;

FIG. 11 shows an illustrative screen view of a yard/prevention selection interface of the tick prevention system of FIG. 1;

FIG. 12 shows an illustrative screen view of a personal prevention selection interface of the tick prevention system of FIG. 1;

FIG. 13 shows an illustrative screen view of a risk calculation interface of the tick prevention system of FIG. 1;

FIG. 14 shows an illustrative screen view of a personal risk score analysis interface of the system of FIG. 1;

FIG. 15 shows an illustrative screen view of a personal risk interpretation analysis interface of the system of FIG. 1;

FIGS. 16-18 show illustrative screen views of three personal risk reduction recommendation interfaces of the system of FIG. 1;

FIG. 19 shows an illustrative screen view of a final interface of the system of FIG. 1; and

FIGS. 20A-20C show illustrative inclusion/exclusion heuristics in the processing method of the system of FIG. 1.

The drawings are shown for illustrative purposes only.

### DETAILED DESCRIPTION

Systems of the invention provide a high graphic quality, interactive, user-friendly, health promotion tool for guiding appropriate tick bite protection and tick borne disease prevention behavior and actions. This decision support product uses published and unpublished information related to risk for human encounter with the blacklegged tick (Ixodes scapularis) vectors of Lyme disease, to create a weighted empirical model of tick encounter risk in peridomestic (backyard) settings. The model integrates geographically-based risk data, habitat characterization, human activity patterns, and current tick bite prevention practices to calculate a personalized risk score (0 to 100) and to provide a tick bite protection and tick-borne disease prevention action plan customized for each user.

The empirical model is based on several factors, including: a) 17 continuous years of TickEncounter Risk Surveillance in Rhode Island and an average tick encounter risk map based on these data (see www.tickencounter.org/interaction/rhode_island_map/); b) correlation of geographic tick distribution data with human Lyme disease incidence information for Rhode Island, which is being used to generate a statistical model for classifying tick encounter risk for towns in other northeastern USA states where tick data are not available but disease data are; c) images of high, moderate, and low risk backyard habitats for comparison to the user's own yard type; d) presence/absence of other recognized risk-related parameters (pets, wildlife); e) the level of selected human tick encounter risk activities (gardening, leaf raking, brush clearing, playing) common to most peridomestic settings; and f) the degree to which personal and landscape-based tick bite protection practices are currently being used. Systems of embodiments of the invention include a computer code that integrates the above-mentioned tick encounter risk factors, an interactive, user-friendly interface, as well as data storage and retrieval capacity.

An aspect of an embodiment is that it may be calibrated by comparing calculated user scores to field-measured levels of tick encounter and disease risk. The system may further be provided to areas where cases of Lyme disease are recorded and reported but tick surveillance data are lacking. More than 30 million USA households could benefit from assessing their encounter risk with blacklegged ticks and learning to take appropriate actions to reduce disease.

The invention, therefore, provides a system that is both interactive and data-driven, and is an expert-based health promotion tool with an extremely user-friendly interface designed to guide and support appropriate tick bite protection and tick borne disease prevention behaviors and actions.

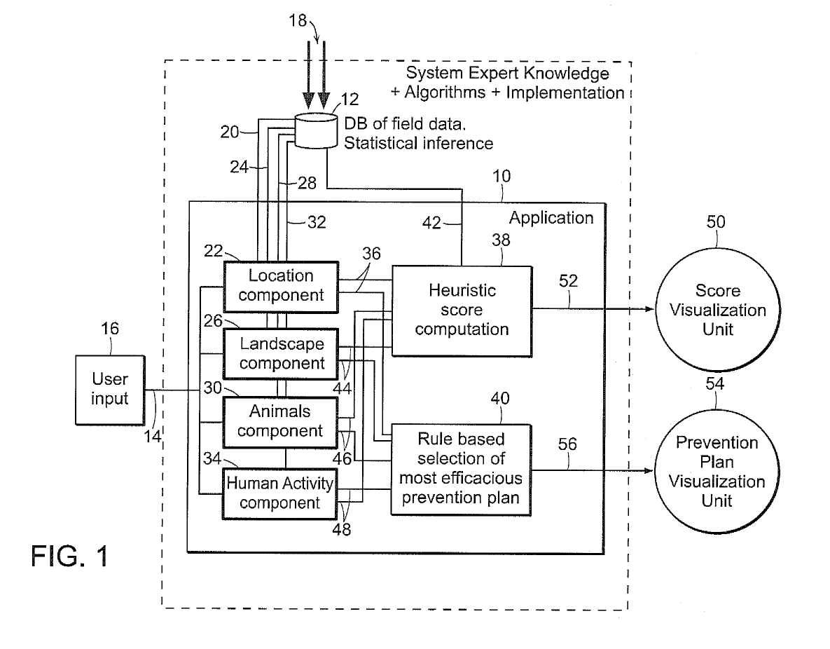

FIG. 1, for example, shows a schematic illustration of a four-component tick encounter risk calculator model showing the relationship between a database of field-derived risk data and a user input device that are employed to calculate a unique risk score as well as derive a tick encounter risk reduction action plan tailored to the unique user input data. In particular, the system includes an application 10 that receives input regarding field data from a database 12 of field data, as well as user input 14 via a user input device 16. The database input from the database 12 is periodically updated as shown at 18.

The database 12 is initially created and is a repository for (a) data collected over the course of several years by field biologists and epidemiologists, and (b) statistical information inferred from these data. Continuous updates of the field data allow automatic adjustments of the heuristics and rules of the system's computational modules. The database 12 provides location data 20 to a location component 22, provides landscape data 24 to a landscape component 26, provides animals data 28 to an animals component 30, and human activity data 32 to a human activity component 34.

The location component 22 exploits information from the database about geographically-referenced estimates of nymphal blacklegged (Ixodes scapularis) tick abundance and its correlation with Lyme disease cases over a multiple-year period. The geo-spatial estimators produced by this module concern the base risk of encountering a Lyme disease-carrying tick, regardless of other factors. As they become available, additional databases containing information on other tick species and life stages also are relevant to this component. A location value 36 is provided to a heuristic score computation unit 38 and to a rule-based selection of the most efficacious prevention plan unit 40, customized for the user based on their input. The heuristic score computation unit 38 is also coupled to the database 12 for receiving statistical inference data 42 from the database 12.

The landscape component 26 interprets information provided by users about their own yard in light of knowledge stored in the database about tick encounter risk factors associated with various elements of landscape. User input comes in two forms: global information that is provided when users select images of yards that look most like theirs, and feature information when they provide answers to questions about specific elements of their yard (woods' edge, presence of a stonewall, etc.). The combination of user input and database knowledge allows the calculator model to (1) compute a general risk level for the yard; (2) identify elements of the landscape that correspond to reduced tick encounter risk (i.e. lack of forest edged yard) even in geo-referenced high tick encounter risk areas and that could be addressed by the prevention module; (3) identify discrepancies between users' perception of their yard's key features pertaining to tick bite prevention and actual expert knowledge about factors contributing to tick encounter risk. A landscape value unit 44 is provided to the heuristic score computation unit 38 and to the rule-based selection of most efficacious prevention plan unit 40.

The animals component unit 30 focuses on the role of common companion animals (cats and dogs) in bringing ticks from the yard into the house or to people, thereby contributing to human tick-encounter risk, as well as optionally identifying whether certain rodents (disease reservoirs) or deer (tick reproductive hosts) live in the area. Queries to users concern the frequency and extent of both wildlife and pets' presence in the yard and its surroundings. The animals component of the system uses estimates from published literature of the increased likelihood for human tick encounter and/or disease risk as a result of specific activities of wildlife and pets in the peridomestic habitat. It also identifies discrepancies between users' perception of possible vulnerabilities in their defense against tick bites/disease that pertain to pets and actual expert knowledge about how pets contribute to tick encounter risk, which can be investigated by the prevention module. An animals value unit 46 is provided to the heuristic score computation unit 38 and to the rule-based selection of most efficacious prevention plan unit 40 tailored to unique user input data.

The human activity component unit 34 takes into account how people use their yard (gardening, playing, etc.) as well as what kind of actions they may already be taking to protect themselves (i.e., wearing tick repellent clothing, self or professional yard treatments, daily tick-checks, etc.). This component generates both behavior-driven and prevention-driven values that contribute to the risk score. It also identifies discrepancies between users' perception of possible vulnerabilities in their defense against tick bites/disease that pertain to their activities in the peridomestic environment and actual expert knowledge about how such activities contribute to tick encounter risk, which can be addressed by the tick encounter risk reduction action plan tailored to unique user input data. A human activity value unit 48 is provided to the heuristic score computation unit 38 and to the rule-based selection of most efficacious prevention plan unit 40.

The heuristic score computation unit 38 combines the partial scores (the location value 36, the landscape value 44, the animals value 46 and the human activity value 48) computed by the location, landscape, animals, and human activity components to calculate a global risk index value estimating the users' unique risk of encountering ticks and potentially contracting Lyme disease or other tick-borne diseases while in their yard, whether directly or indirectly (through a pet). The four different partial scores are combined (e.g., by weighted summation) by a heuristics process that takes into account field data and published or unpublished findings covering a multi-year period to provide heuristics summation data 52 to a score visualization unit 50 that provides the score to the user.

The tick encounter prevention plan module 40 uses a rule-based method to produce the most efficacious action plan for reducing tick encounter risk tailored to the particular user based on their responses. For example, similar levels of human activity may result in comparable global risk indexes for a low-risk yard in a high-risk area and a high-risk yard in a medium-risk area, but the most efficacious action plans for both yards are likely to be very different. The tick encounter prevention plan module's rule-based method generates plan data 56 that includes both a listing of applicable prevention actions and ranks them in order of expected benefit for each specific user. The prevention plan visualization unit 54 presents the plan to the user via a listing of applicable prevention actions ranked in order of expected benefit.

The system is designed for convenience in updating all components and modules; changes in the field database (such as a temporary increase of tick presence in some locations, or addition of databases containing information on other tick species or stages) can easily be modified, as can the weights given to each component in all of the modules.

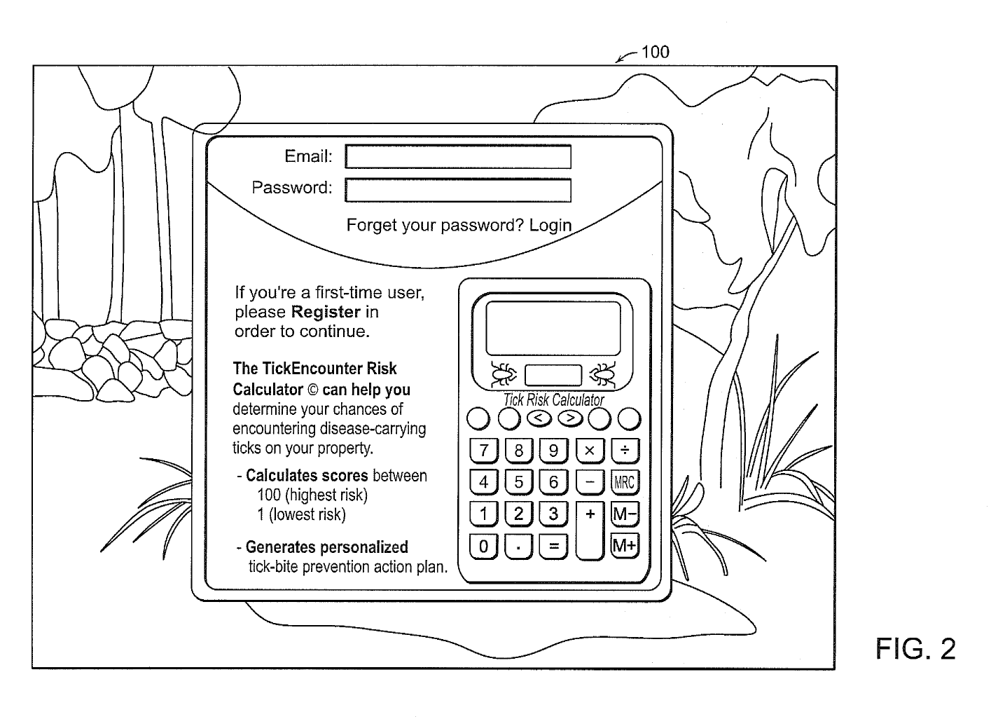

As shown at 100 in FIG. 2, a user interface application program of the invention begins by permitting a user to register as a prior user of the system, or to enter as a new user of the system. This is done so that prior data regarding the user may be accessed from the database 12 and used in generating a current analysis. A calculator is shown for illustrative purposes.

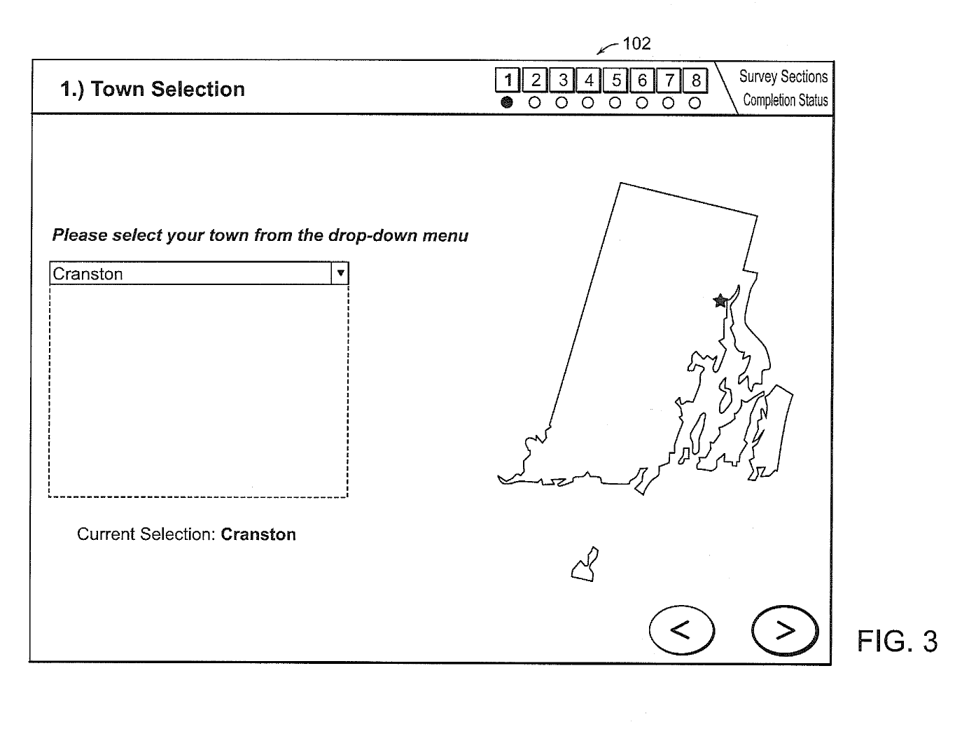

As shown at 102 in FIG. 3, a next screen permits users to enter the name of the town in which they live (e.g., Cranston as shown). The location component 36 may then select a value (e.g., between 0 and 25) based on a rating of low to high risk town assignment values. Such low to high risk town assignment values are generated based on the database 12 that includes the human encounter data mentioned above. For example, each town assignment value may be set to 0-25 based on a direct conversion of its tick encounter value (counts of encounters over a specified period of time) versus the highest encounter value for the highest risk town. In other embodiments, the encounter values may be grouped in five or six set levels.

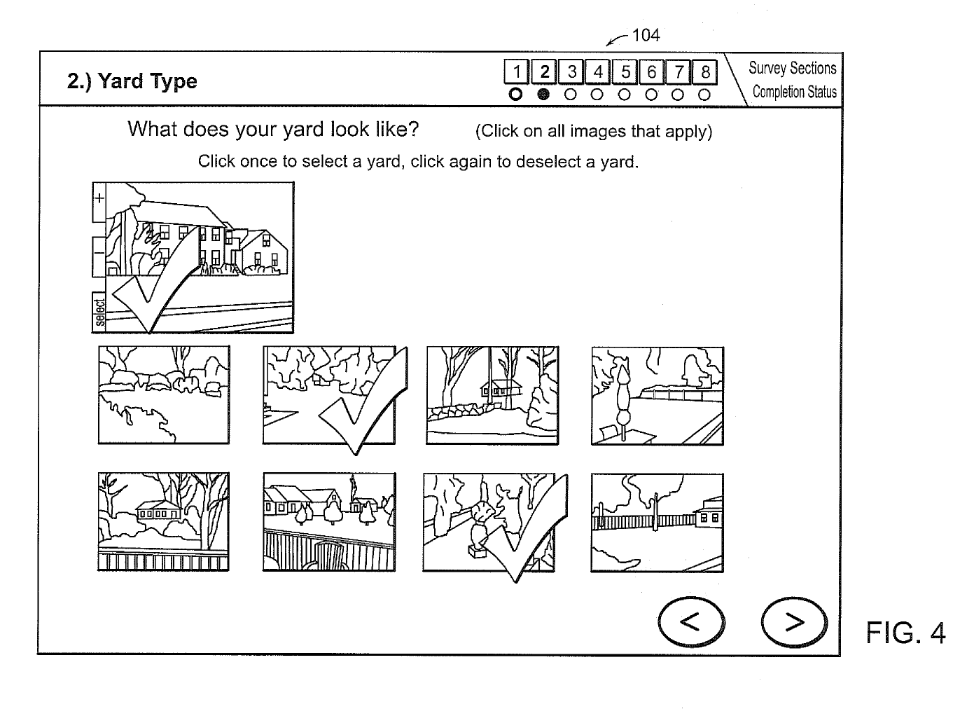

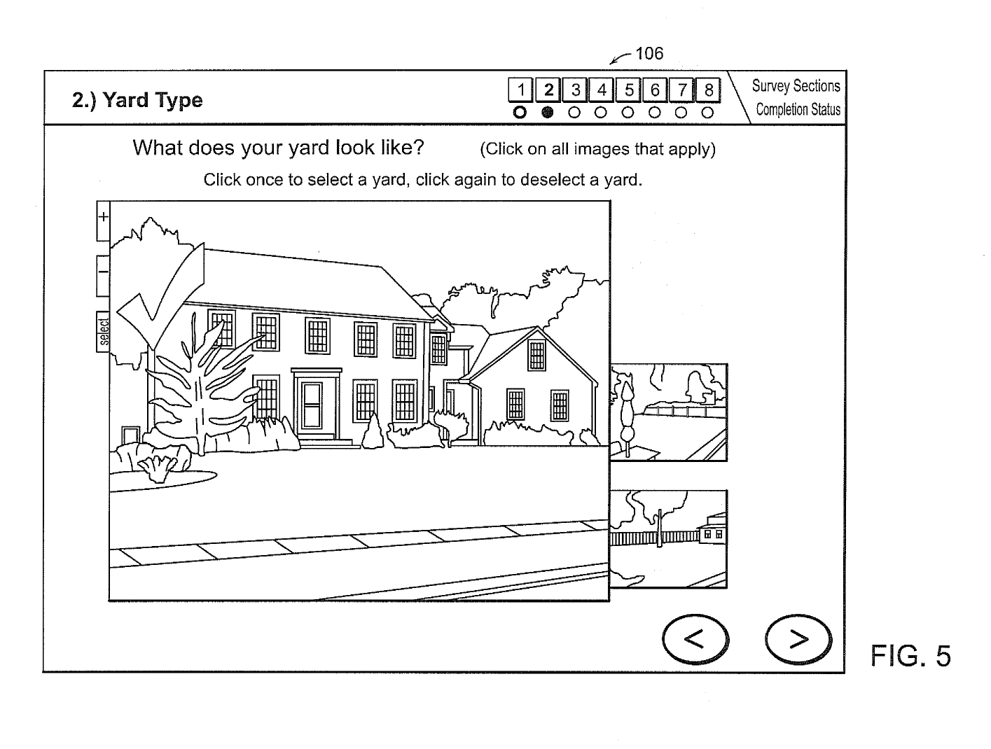

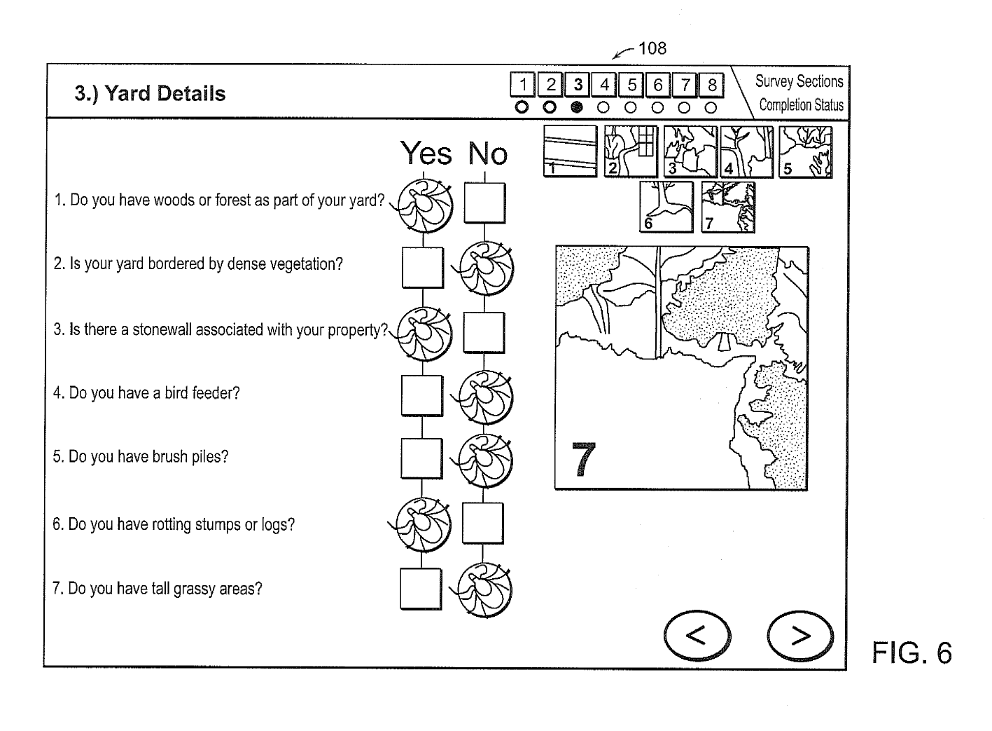

As shown at 104 in FIGS. 4 and 106 in FIG. 5, the system then provides a variety of yard analogy options from which the user may select an image and description of a yard that most resembles their yard. Pictures of each item are also shown for the convenience of the user. A landscape value may then be determined by a pre-determined ranking of the yard scenes (e.g., from lowest to highest risk as 10, 12, 14, 16, 18, 20, 22, 24). As shown at 108 in FIG. 6, the system then queries the user to elect (yes/no) whether their yard includes any of the following: woods or forest as part of the yard, a border of dense vegetation, a stonewall, a bird feeder, brush piles, rotting stumps or logs, and tall grassy areas. For each response that is a “yes”, the system would add a predetermined number of additional points (e.g., 5 points each), while not exceeding a maximum of 25, to provide the landscape value 44.

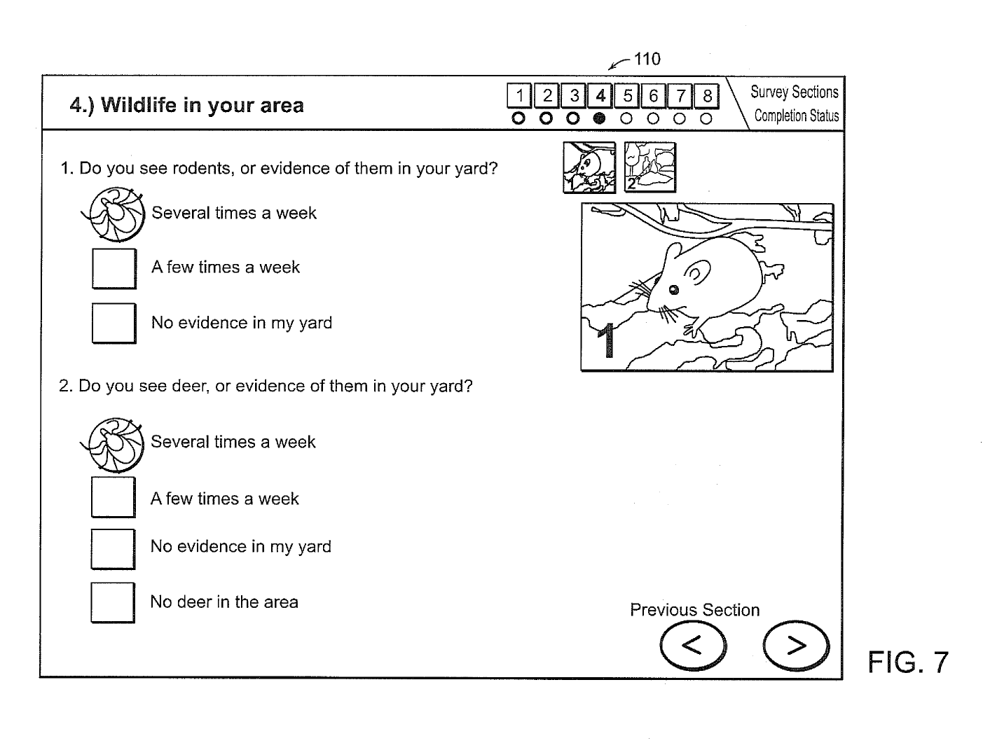

As shown at 110 in FIG. 7, the system then inquires about wildlife in the area. First, a user is asked whether the user sees rodents or evidence of rodents in the yard 1) several times a week, 2) a few times a week or 3) not at all. The system then asks whether the user sees deer or the presence of deer 1) several times a week, 2) a few times a week or 3) not at all. Again, pictures of each are provided. A response of “a few times a week” generates an initial value of, for example, 10 for each such answer, and a response of “several times a week” generates a value of, for example, 15 for each. The values are summed, again not exceeding 25 if this maximum is reached, and the system then queries about pets.

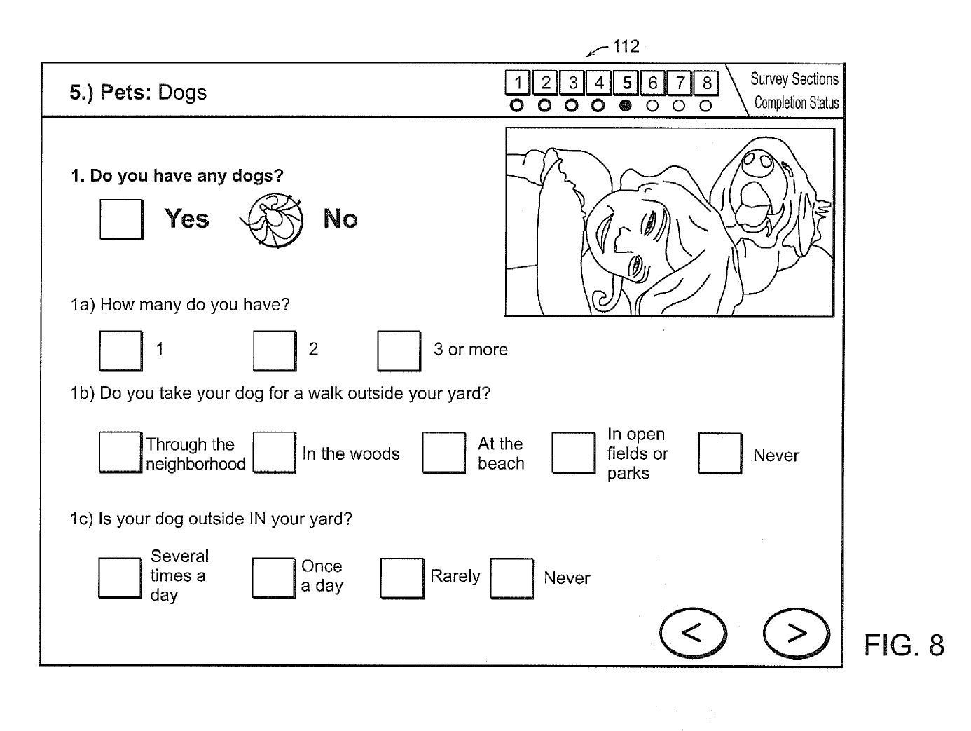

As shown at 112 in FIG. 8, the system then asks whether the user lives with any dogs. If yes, then the user is asked how many dogs (1, 2, or more than 2). The user is then asked whether the user takes the dog(s) for walks 1) through the neighborhood, 2) in the woods, 3) at the beach, 4) in open fields or parks, and/or 5) not at all. The system then asks whether a dog is outside in the yard 1) several times a day, 2) once a day, 3) rarely, or 4) never. If the user has at least one dog, for example, the prior summed value may be increased, for example, by the value 3 for each dog. If the user answers yes to any of the responses in items 1b and 1c, the current summed value may be increased by 3 for each such response. The running values are then summed, again not exceeding 25, as the animals component continues.

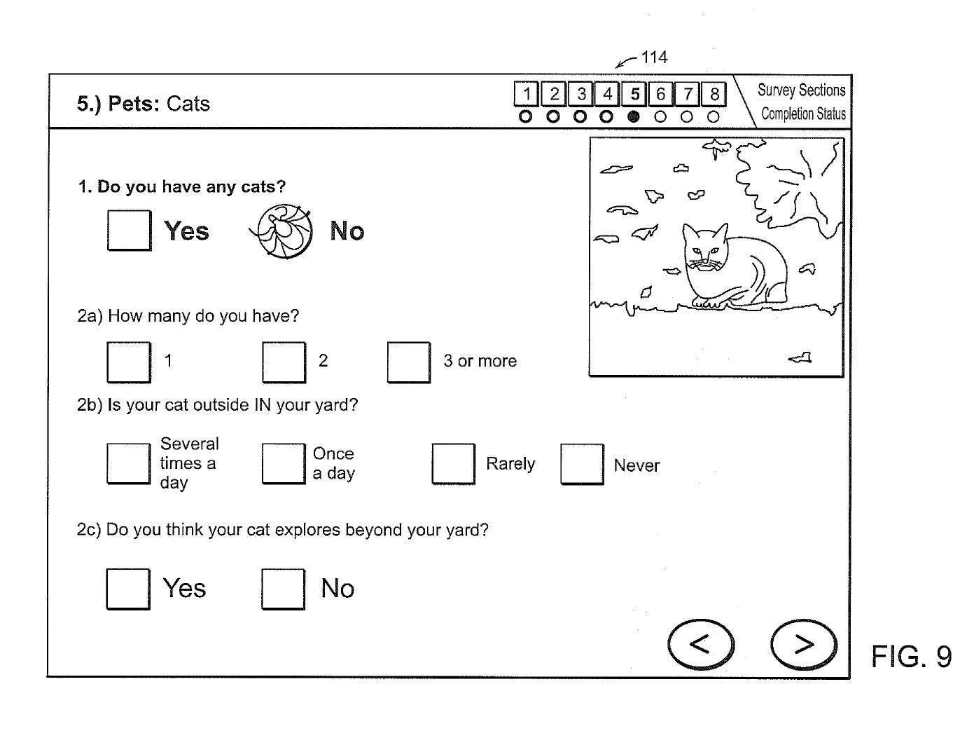

As shown at 114 in FIG. 9, the system then asks whether the user lives with any cats. If so, the user is asked how many cats (1, 2, or more than 2). The user is then asked whether a cat is outside in the yard 1) several times a day, 2) once a day, 3) rarely, or 4) never. The system then asks whether you believe that a cat explores beyond the yard (yes/no). If the user has at least one cat, for example, the prior summed value may be increased, for example, by the value 3 for each cat. If the user answers yes to any of the responses in items 2b and 2c, the current summed value may be increased by 3 for each such response. The total sum, again not exceeding 25, is then provided as the animals value 46.

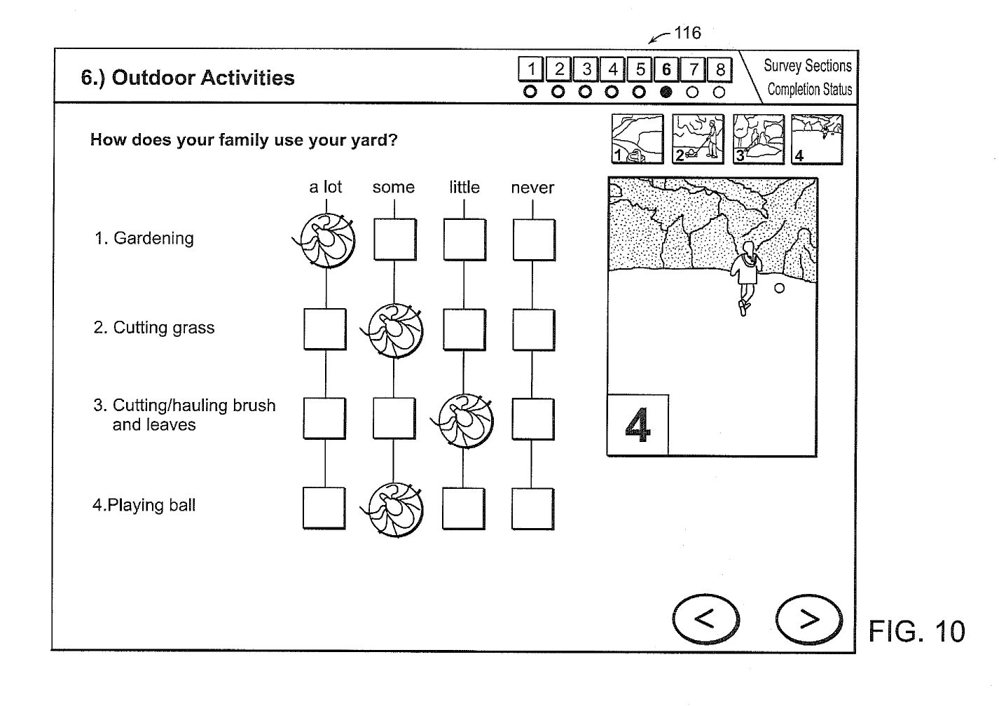

As shown at 116 in FIG. 10, the system then asks about the families' use of the yard. In particular, with respect to each of gardening, cutting grass, cutting/hauling brush and leaves, and playing ball, then system asks whether each activity occurs a lot, some, little, or never. Again, pictures of each are shown for the user's convenience. Responses of “a lot” may be valued, for example, at 5 points each, while response of “some” may be 4 points each, while responses of “little” may be 2 points each. A running sum is determined as the human activity component continues.

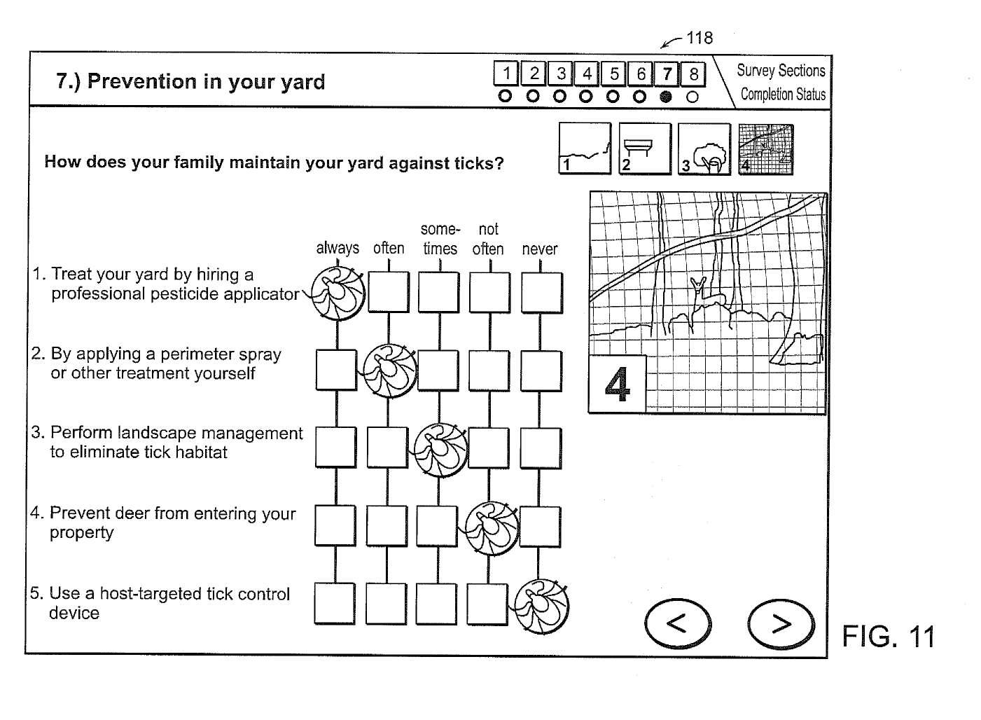

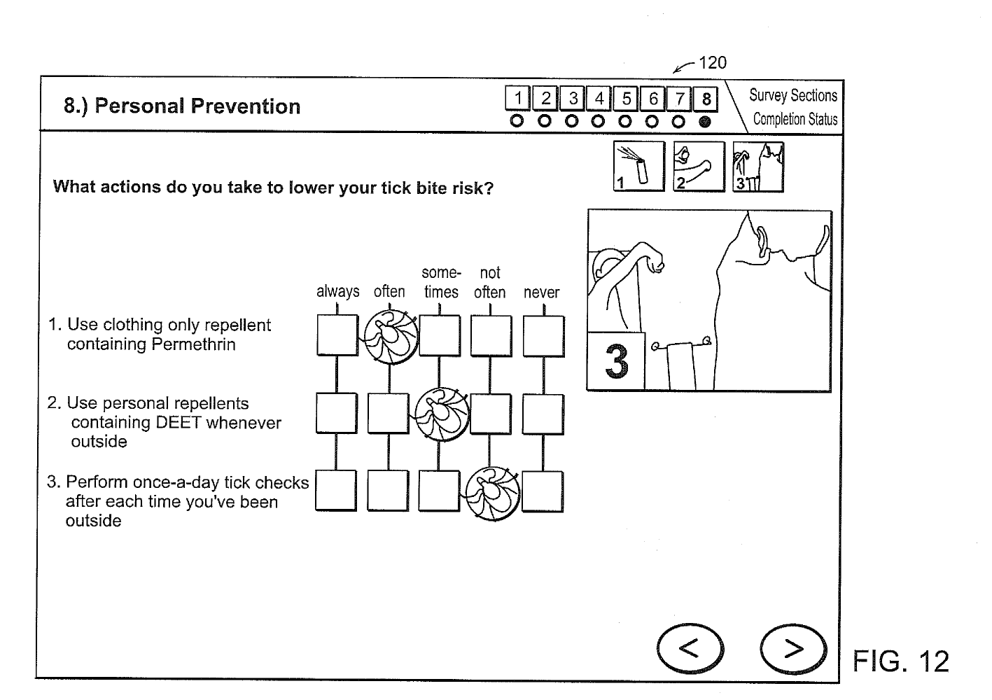

As shown at 118 in FIG. 11, the system then asks about tick prevention activities that occur in the yard. In particular, for each of the activities of 1) treating the yard by hiring a professional pesticide applicator, 2) applying a perimeter spray or other treatment by yourself, 3) performing landscape management to eliminate tick habitat, 4) preventing deer from entering the property, and 5) using a host-targeted tick control device, the systems asks whether each such activity is undertaken always, often, sometimes, not often or never. Again, photos of activities are provided for the user's convenience. As shown at 120 in FIG. 12, the system then asks about personal prevention actions taken by the user, including does the person 1) use clothing only repellent containing Permethrin, 2) use personal repellents containing DEET whenever outside, and 3) perform once-a-day tick checks after each time the have been outside. For each of these, the user is asked to elect a response of always, often, sometimes, not often or never. Each of the responses in the screens shown in FIGS. 11 and 12 of “always” may increase the running value by 1 point, while each response of “often” may increase the running value by 2 points, “sometimes” by 3 points, “not often” by 4 points, and “never” by 5 points respectively. The total sum, again not exceeding 25, is then provided as the human activity value 46.

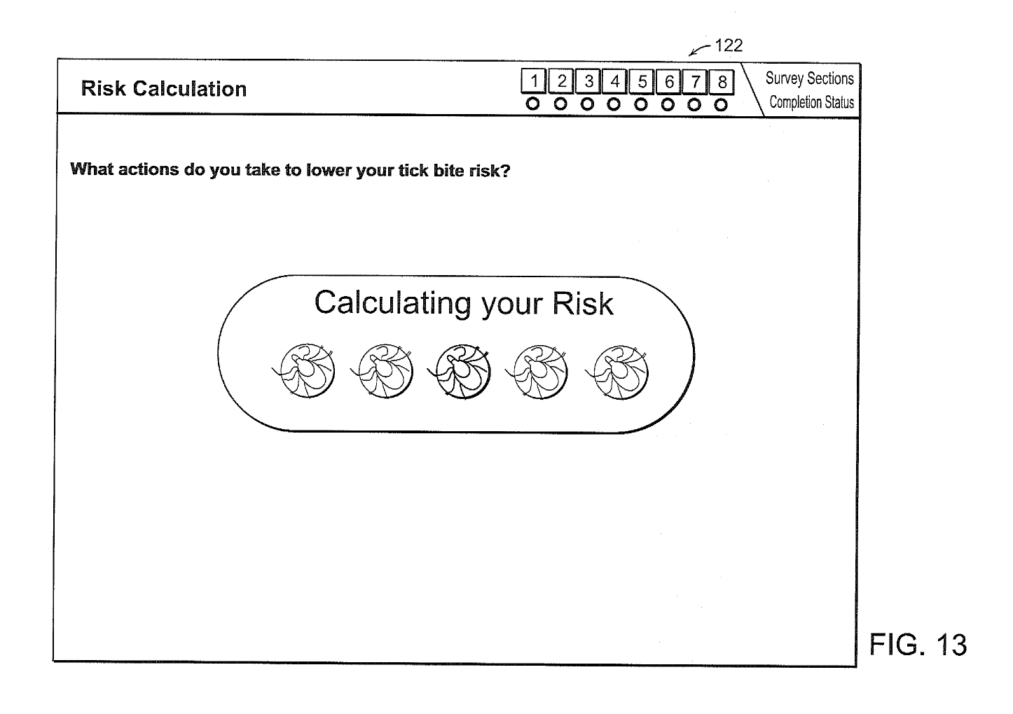

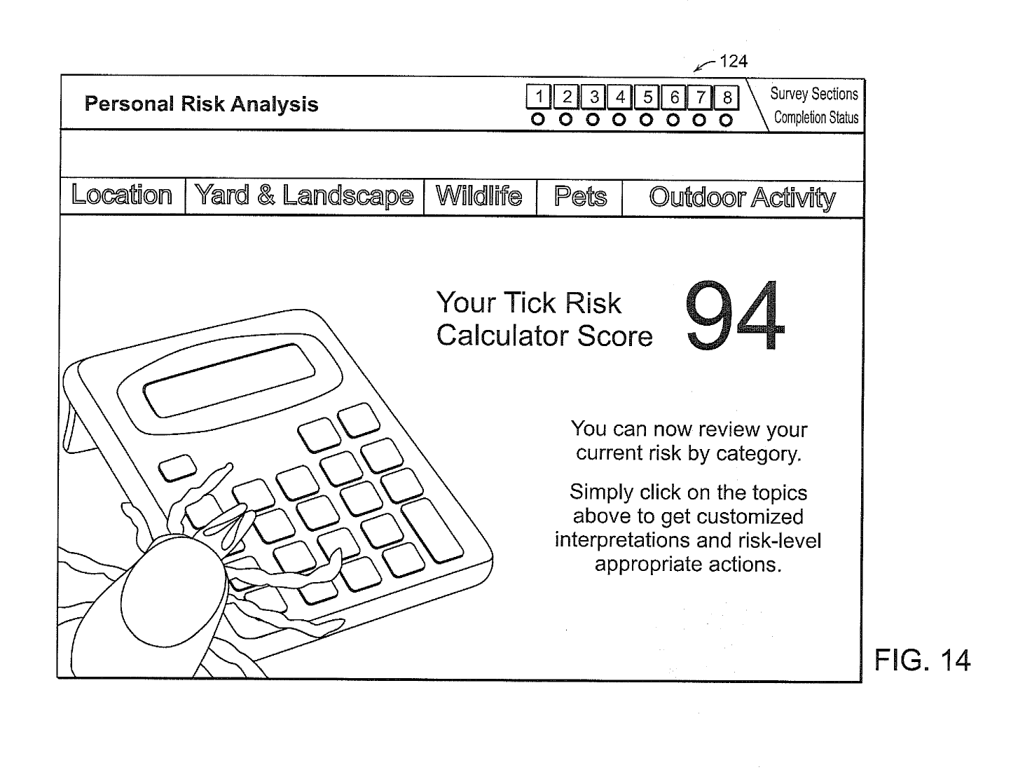

As shown at 122 in FIG. 13, the system then shows that a risk calculation is being performed, and as shown at 124 in FIG. 14, the system then provides a tick risk calculation score, which as discussed above may be the sum of the location value 36, the landscape value 44, the animals value 46 and the human activity value 48.

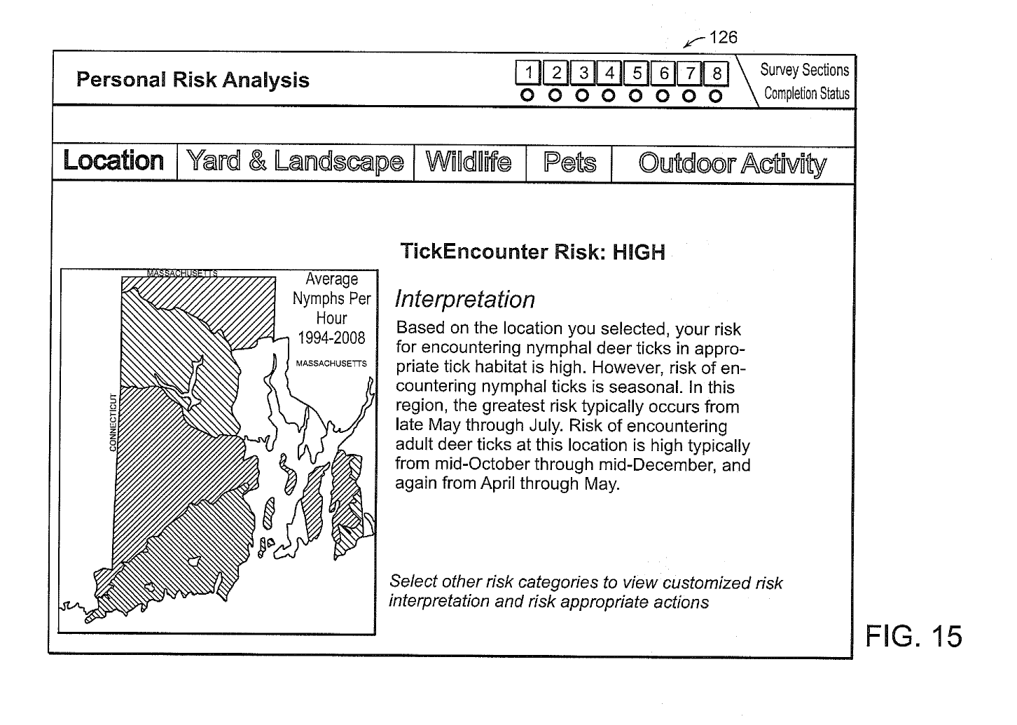

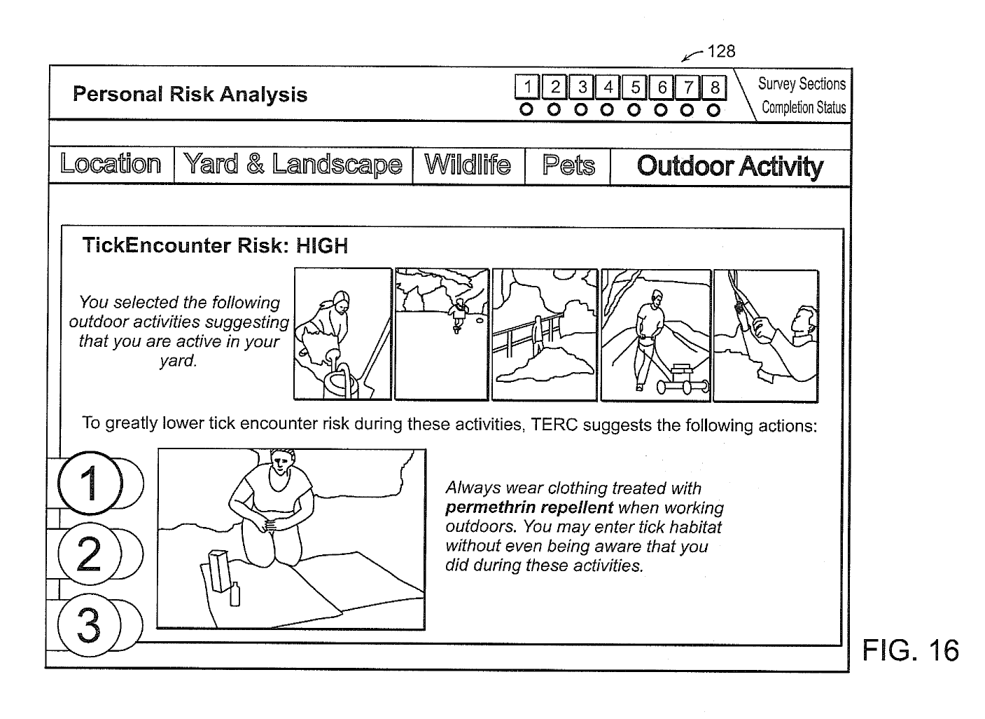

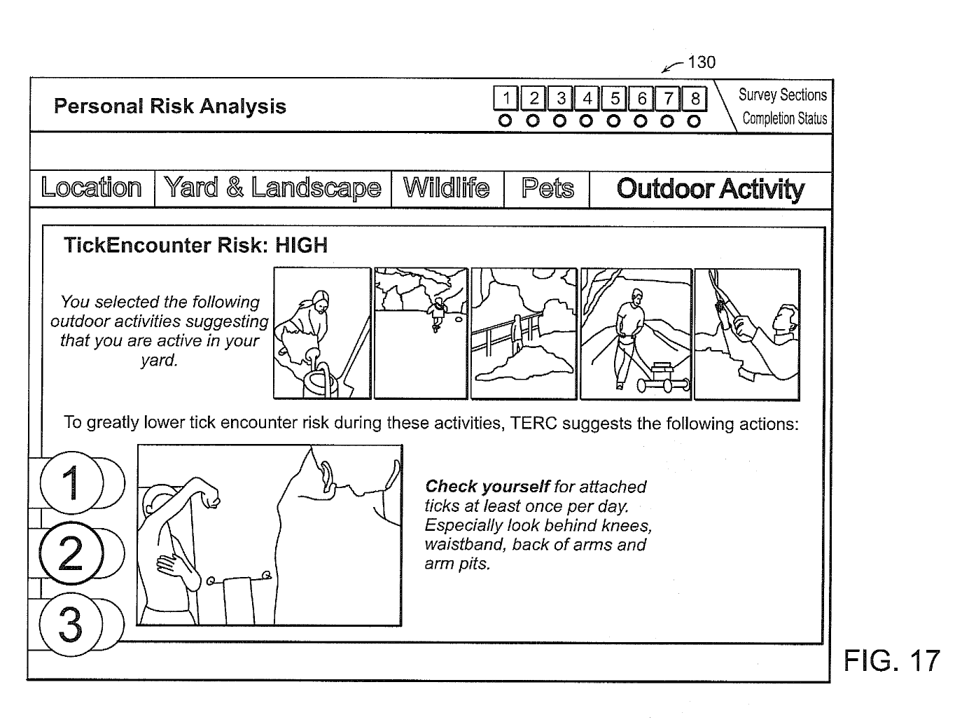

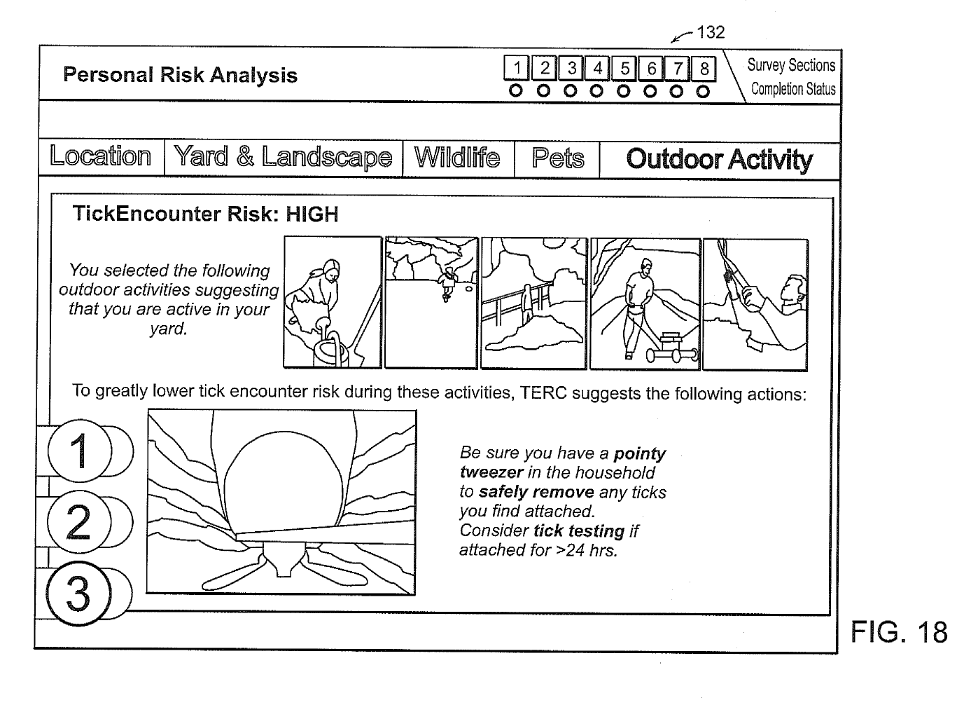

For each of the categories (location, yard & landscape, wildlife, pets and outdoor activity), the system also permits the user to view feedback regarding each category. For example, as shown at 126 in FIG. 15, a location feedback screen may show that the user's risk of encountering nymphal deer ticks is high. As shown at 128 in FIG. 16, the system may advise that a user should always wear clothing treated with permethrin repellent when working outdoors, and as shown at 130 in FIG. 17, the system may advise that the user should check themselves for ticks at least once per day. To remove a tick, the system may advise to use a pointy tweezer as shown at 132 in FIG. 18.

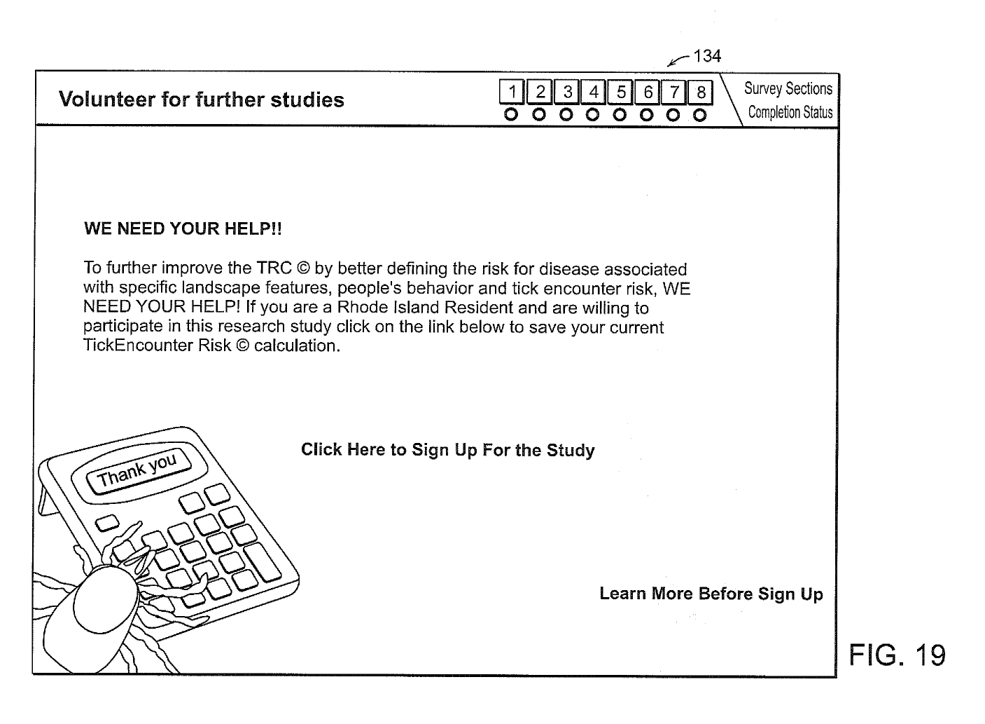

As shown at 134 in FIG. 19, the program may end with a plea for more data to be submitted to the database to ensure that the database records remain updated and become as complete as possible over time.

In further embodiments, the system may begin with a score of 100 and subtract points based on the appropriate level of risk associated with the response options for each of the categories (location, yard & landscape, wildlife, pets and outdoor activity) discussed above. For example, living in a high tick encounter risk town might subtract zero points, whereas living in a low tick encounter risk town might subtract five or ten points.

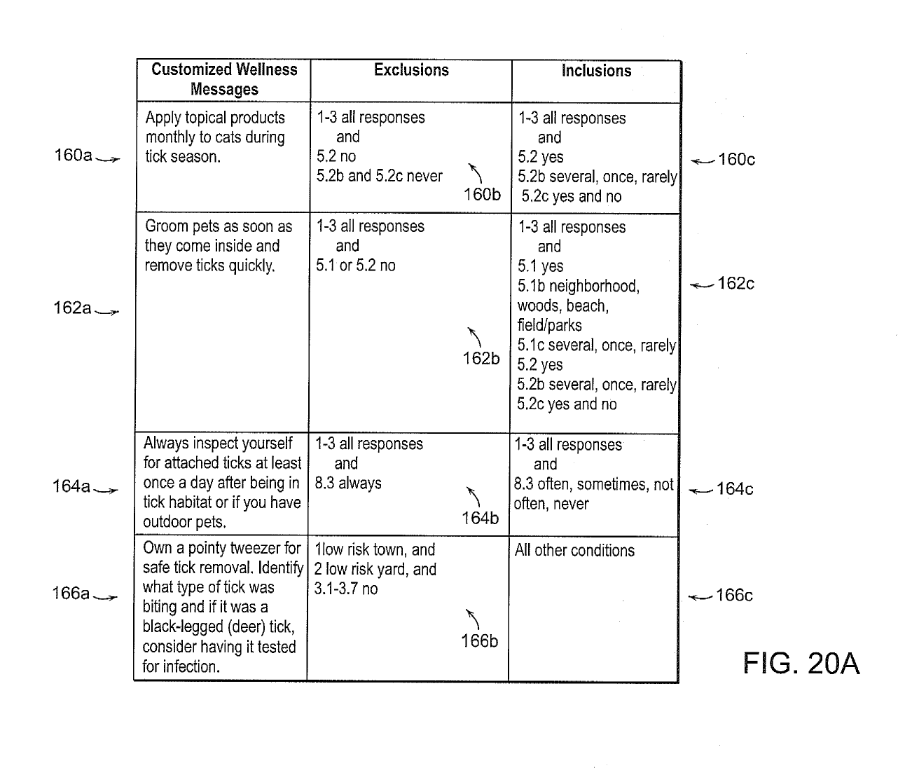

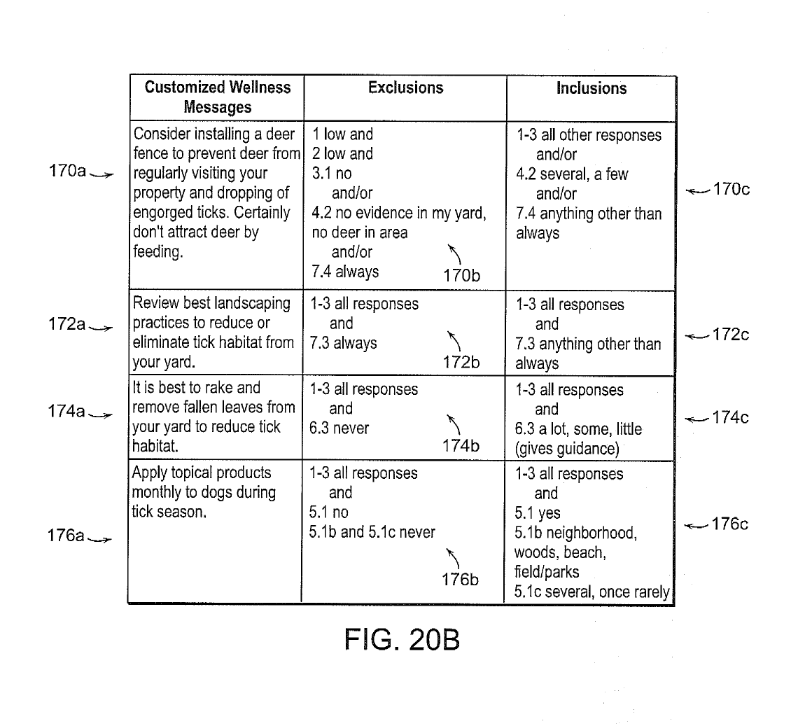

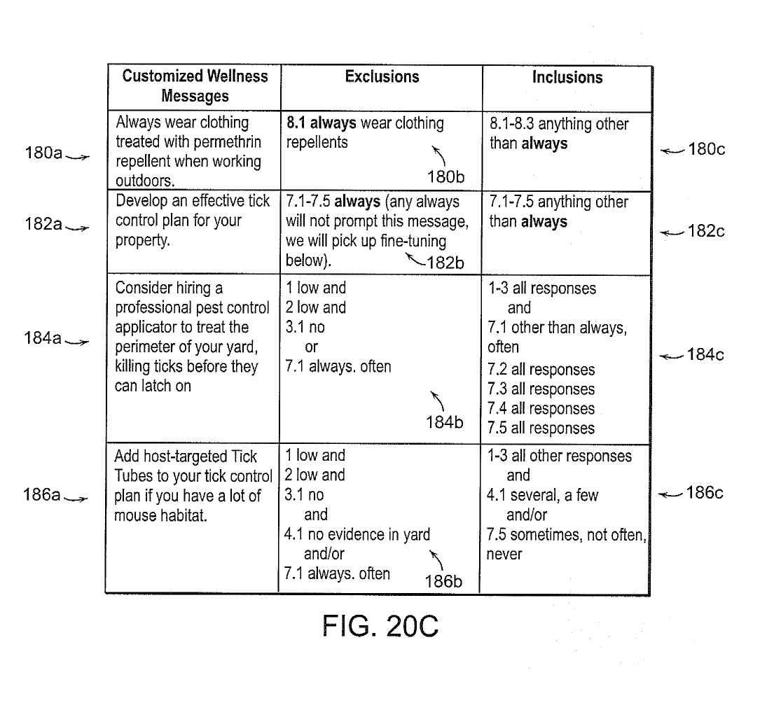

The rules and exclusions employed in the recommendation and prevention plan unit 40 in a system of an embodiment of the invention are shown in FIGS. 20A-20C. In particular, FIG. 20A shows at 160a, 162a, 164a and 166a customized wellness messages, and shows at 160b, 162b, 164b and 166b, any exclusions that apply to the associated messages. FIG. 2A shows at 160c, 162c, 164c and 166c the associated inclusions. For example, unless a user had entered data indicating that it either had no cats or that cats never enter the yard or go beyond the yard as shown at 160b (indoor only cats), then the message to apply topical products to cats during the tick season shown at 160a would be generated. If a user indicated that they either had a dog or had a cat that went outside (162c), then the user would be advised to groom the pets as soon as they come inside and to promptly remove any ticks (162a). Unless a user indicated that they always perform tick-checks when they come inside (164b), then the system would advise that they do so (164a). Unless the user entered data indicating that they live in a low risk town (166b), the system would advise that they should own a pointy tweezers to facilitate safe tick removal (166a).

FIG. 20B shows at 170a, 172a, 174a and 176a additional customized wellness messages, and shows at 170b, 172b, 174b and 176b, any exclusions that apply to the associated messages. FIG. 20B shows at 170c, 172c, 174c and 176c the associated inclusions. In particular, as shown at 170b, unless a list of exclusions apply (low risk town and low risk yard, and no woods near the yard or no evidence of deer, and deer are always prevented from entering the yard, then a message to consider installing a deer fence (170a) would be provided. Unless a user indicates that they always perform landscape management to eliminate tick habitat (172b), the system will advise that they do so (172a). Unless a user indicates that they never cut or haul brush or leaves (174b), then they will be advised to rake and remove fallen leaves from the yard (176a). Unless a user indicates that they have no dogs (or that they are indoor-only dogs) as shown at 176b, the system will advise that the user apply topical products monthly to any such dog(s) as shown at 176a.

FIG. 20C shows at 180a, 182a, 184a and 186a customized wellness messages, and shows at 180b, 182b, 184b and 186b, any exclusions that apply to the associated messages. FIG. 20C shows at 180c, 182c, 184c and 186c the associated inclusions. For example, if a user provides input data indicating that they responded other than always to a question of whether they wear clothing treated with permethrin repellent when working outdoors (180c), then the system will provide feedback advising that they always wear clothing treated with permethrin repellent when working outdoors (180a). The rule shown at 180b is therefore the exclusion for this message of 180a. Similarly, the message at 182a of “Develop an effective tick control plan for your property” will arise if the user entered any response other than that they always have a control plan in place. The message to consider hiring a professional pest control applicator to treat the perimeter of the yard (184a) will arise unless the user entered data indicating that they live in a low risk town and have a low risk yard, and have no pets or either always or often have the yard treated by a professional pest control applicator (184b). Unless a user indicates that they live in a low risk town and have a low risk yard, and have no pets and either have no evidence of mice in the yard or always or often use a host-targeted tick control device (186b), then the system will advise that they add host-targeted tick tubes to a tick control plan (186a).

Those skilled in the art will appreciate that numerous modifications and variations may be made to the above disclosed embodiments without departing from the spirit and scope of the invention.

What is claimed is:

1. A tick encounter prevention system for permitting a user to obtain a risk calculation of contacting a tick, said tick encounter prevention system comprising:
a location component for receiving data from a user regarding a user's geographic location;
a landscape component for receiving data from the user regarding the type of landscape and habitat that exists where the user lives;
an animals component for receiving data from the user regarding the occurrence of any wildlife activity or the presence of pets that exist where the user lives;
a human activity component for receiving data from the user regarding the user's activities in their yard and any existing tick-bite protection practices;
a database on which statistical inference data is stored, said database being coupled to each of the location component, landscape component, animals component and human activity component; and
a score computation module for generating a tick encounter risk calculation number based on output data from each of the location component, the landscape component, the animals component and the human activity component.

2. The system as claimed in claim 1, wherein said system further includes a prevention plan module for providing customized, risk level appropriate preventive actions based on the output data from each of the location component, the landscape component, the animals component and the human activity component.

3. The system as claimed in claim 2, wherein said prevention plan module provides rule-based selection data responsive to inclusions and exclusions that are triggered by the user input data received by at least each of the landscape component and the human activity component.

4. The system as claimed in claim 3, wherein said inclusions and exclusions are further triggered by the user input data received by the location component and the animal component.

5. The system as claimed in claim 4, wherein said rule-based selection data for a recommended prevention action includes inclusions and exclusions relating to each of the location component, the landscape component, the animals component, and the human activity component.

6. The system as claimed in claim 1, wherein said database includes data about geographically-referenced estimates of nymphal blacklegged (Ixodes scapularis) tick abundance and its correlation with Lyme disease cases over a multiple-year period.

7. The system as claimed in claim 6, wherein said data about geographically-referenced estimates of nymphal blacklegged (Ixodes scapularis) tick abundance and its correlation with Lyme disease cases over a multiple-year period is periodically updated.

8. The system as claimed in claim 1, wherein said animals component receives input data from the user regarding pets that live at the user's house, and receives input data from the user regarding rodent and deer activity that may occur in and around the property.

9. The system as claimed in claim 1, wherein said human activity component receives input data from the user regarding how the yard is used, prevention activities that occur in the yard, and personal prevention actions.

10. A method of providing a risk calculation of a user encountering a tick, said method comprising the steps of:
receiving data from a user regarding a user's location;
receiving data from the user regarding a type of landscape that exists where the user lives;
receiving data from the user regarding occurrence of wildlife or pets that exist where the user lives;
receiving data from the user regarding the user's activities in their yard;
storing statistical inference data on a database, said database being coupled to each of the location component, landscape component, animals component and the human activity component; and
generating a tick encounter risk calculation number responsive to the data from a user regarding a user's location, the data from the user regarding a type of landscape that exists where the user lives, the data from the user regarding any wildlife or pets that exist where the user lives, and the data from the user regarding the user's activities in their yard and existing tick-bite protection practices.

11. The method as claimed in claim 10, wherein said method further includes the step of providing recommended prevention actions responsive to the data from a user regarding the user's location, the data from the user regarding a type of landscape that exists where the user lives, the data from the user regarding any wildlife or pets that exist where the user lives, and the data from the user regarding the user's activities in their yard.

12. The method as claimed in claim 11, wherein said step of providing recommended prevention actions responsive to the data from the user includes employing rule-based selection data responsive to inclusions and exclusions that are triggered by the user input data regarding the type of landscape that exists where the user lives, and regarding the user's activities in their yard.

13. The method as claimed in claim 12, wherein said inclusions and exclusions are further regarding the user's location, and the data from the user regarding any wildlife or pets that exist where the user lives.

14. The method as claimed in claim 12, wherein said rule-based selection data for a recommended tick-bite prevention action includes inclusions and exclusions regarding each of the user's location, the data from the user regarding a type of landscape that exists where the user lives, the data from the user regarding any wildlife or pets that exist where the user lives, and the data from the user regarding the user's activities in their yard.

15. The method as claimed in claim 10, wherein said database includes data about geographically-referenced estimates of nymphal blacklegged (Ixodes scapularis) tick abundance and its correlation with Lyme disease cases over a multiple-year period.

16. The method as claimed in claim 15, wherein said method further includes the step of periodically updating the data about geographically-referenced estimates of nymphal blacklegged (Ixodes scapularis) tick abundance and its correlation with Lyme disease cases over a multiple-year period.

17. The method as claimed in claim 15, wherein in the absence of specific geo-referenced collection of ticks, said method further includes the step of estimating nymphal blacklegged (Ixodes scapularis) tick abundance based on the incidence rates of Lyme disease in specific towns, counties, or other groupings.

18. The method as claimed in claim 10, wherein said step of receiving data from the user regarding any wildlife or pets that exist where the user lives includes receiving data regarding specific species of rodents and deer that may exist in and around the property.

19. The method as claimed in claim 10, wherein said data from the user regarding the user's activities in their yard includes data from the user regarding how the yard is used, prevention activities that occur in the yard, and personal prevention actions.

20. The method as claimed in claim 10, wherein said user input data may be stored in the database.

21. The method as claimed in claim 10, wherein said method further includes the step of providing assessment data for additional locations over time.
